(19) United States
(12) Patent Application Publication
(10) Pub. No.: US 2014/0232540 A1
(43) Pub. Date: Aug. 21, 2014

(54) SYSTEM, METHOD, AND COMPUTER PROGRAM PRODUCT FOR IMPLEMENTING A POWER SAVING TECHNIQUE USING A PROXIMITY SENSOR CONTROLLED DISPLAY

(71) Applicant: NVIDIA CORPORATION, Santa Clara, CA (US)

(72) Inventor: Shanker S, Vellore (IN)

(73) Assignee: NVIDIA CORPORATION, Santa Clara, CA (US)

(21) Appl. No.: 13/772,273

(22) Filed: Feb. 20, 2013

(51) Int. Cl. H04W 52/02

(52) U.S. Cl. CPC H04W 52/0251
USPC 340/539.11; 340/686.6

(57) ABSTRACT

A system, method, and computer program product for implementing a power saving technique using a proximity sensor to control a state of a display is described. The method includes the step of monitoring a proximity sensor to determine whether a target object is within range of a device. If the target object is within range of the device, then the steps include deactivating a display of the device, or, if the target object is out of range of the device, then the steps include activating the display of the device.

### FIELD OF THE INVENTION

The present invention relates to power management, and more particularly to techniques for controlling the operation of a display device,

BACKGROUND

Mobile electronics devices, such as cellular phones, have become ubiquitous in today's on-the-go society. A large percentage of the population carries a mobile electronics device in their pocket or handbag wherever they go. Extending the battery life of these devices is extremely important to keep users happy that their device maintains power as long as possible. One of the main drains of the battery is the display.

It is very common for a user to brush up against something with the device in his pocket such that a button is pressed. Whenever this happens, the display may turn on because the device is programmed to react to the button event. In other words, by touching the button, the user has inadvertently indicated that he is about to use the device. In actuality, the button was not pressed on purpose and the display causes the battery to drain even though the user is not using the device. This common problem decreases battery life and causes the device to die unexpectedly when the battery runs out of power. Thus, there is a need for addressing this issue and/or other issues associated with the prior art.

### SUMMARY

A system, method, and computer program product for implementing a power saving technique using a proximity sensor to control a state of a display is described. The method includes the step of monitoring a proximity sensor to determine whether a target object is within range of a device. If the target object is within range of the device, then the steps include deactivating a display of the device, or, if the target object is out of range of the device, then the steps include activating the display of the device.

### BRIEF DESCRIPTION OF THE DRAWINGS

FIG. 1 illustrates a flowchart of a method for controlling the display of a mobile electronics device based on input from a proximity sensor, in accordance with one embodiment;

FIG. 2 shows a block diagram of a mobile electronics device, in accordance with one embodiment;

FIG. 3 illustrates a system that includes a device and a target object, in accordance with one embodiment;

FIG. 4 illustrates a flowchart of a method for controlling the display of a mobile electronics device based on input from a proximity sensor, in accordance with another embodiment; and

FIG. 5 illustrates an exemplary system in which the various architecture and/or functionality of the various previous embodiments may be implemented.

### DETAILED DESCRIPTION

Many modern mobile electronics devices include built-in proximity sensors that are configured to detect when the device is close to a target object. For example, the Apple® iPhone includes a proximity sensor that can detect when the display is close to a user's face during a call. However, the proximity sensor is only used to control the display during a call (such as to prevent inadvertent input when the phone is expected to be placed next to a user's face). The power saving technique described below associates input from a proximity sensor with the operation of the display in order to save battery power that could be drained due to inadvertent inputs causing the display to turn on, even when the user is not using the device.

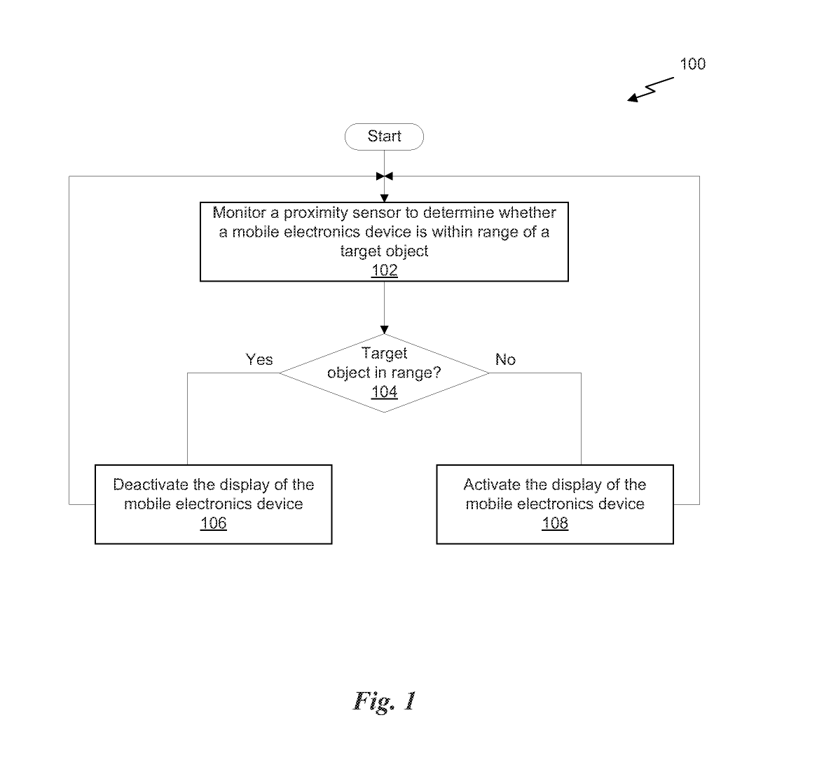

FIG. 1 illustrates a flowchart of a method 100 for controlling the display of a mobile electronics device based on input from a proximity sensor, in accordance with one embodiment. At step 102, a proximity sensor is monitored to determine whether the device is within range of a target object. At step 104, the device determines if the target object is within range. If the mobile electronics device is within range of the target object, then, at step 106, the display of the device is deactivated and control returns to step 102. However, if the device is not within range of the target object, then, at step 108, the display of the device is activated and control returns to step 102.

It should be noted that, while various optional features are set forth herein in connection with this technique for controlling the display of the mobile electronics device, such features are for illustrative purposes only and should not be construed as limiting in any manner. In one embodiment, the control mechanism described above is implemented as part of an operating system for the mobile electronics device.

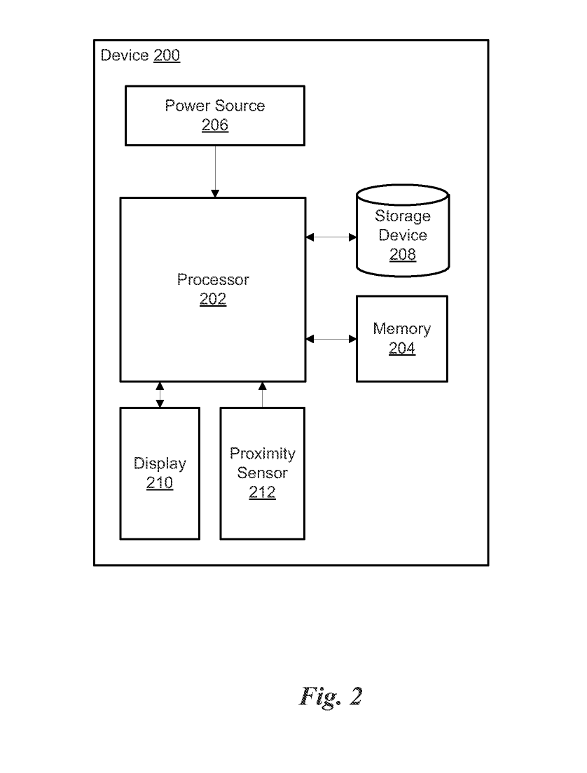

FIG. 2 shows a block diagram of a mobile electronics device 200, in accordance with one embodiment. As shown in FIG. 2, the device 200 includes a processor 202, a memory 204, a power source 206, a storage device 208, a display 210, and a proximity sensor 212. In one embodiment, the processor 202 is a system-on-chip (SoC) such as a Tegra™ processor manufactured by NVIDIA®. The processor 202 may include a reduced instruction set computer (RISC) processor as a central processing unit (CPU) core as well as a specialized parallel processing unit as a graphics processing unit (GPU) core. The processor 202 may also include other digital and/or analog units such as digital-to-analog converters (DAC), video encoders/decoders, a memory interface, and the like. In another embodiment, device 200 may include separate and distinct CPU(s), GPU(s), and the like implemented on different integrated circuits (ICs) and contained within the same or separate package. The different units of the device 200 may be connected to a system bus (not explicitly shown in FIG. 2).

In one embodiment, the memory 204 is a synchronous dynamic random access memory (SDRAM) module that is accessible by the processor 202 via the memory interface. The power source 206 is a battery such as a lithium ion battery. The storage device 208 is a non-volatile memory for storing programs and data. In one embodiment, the storage device 208 is a flash memory device. In another embodiment, the storage device 208 is a solid-state hard drive.

The display 210 is a liquid crystal display (LCD) device. The display 210 may include capacitive multi-touch functionality and/or light-emitting diode (LED) backlighting. In other embodiments, the display 210 may be an organic light-emitting diode (OLED) formed on a flexible film. The display 210 is configured to receive image data (i.e., pixel data) from processor 202 to be displayed on a screen on an external surface of the device 200.

The proximity sensor 212 is an optical proximity sensor having a range of approximately 1-5 centimeters. The proximity sensor 212 may be an ambient light sensor that detects a level of ambient light that is measured by the proximity sensor 212. When the user brings the proximity sensor 212 near an object, the level of ambient light drops below a threshold value and the proximity sensor 212 detects the presence of an object. In another embodiment, the proximity sensor 212 projects light from a LED and measures the amount of light that is reflected back to the proximity sensor 212. As objects get closer to the proximity sensor 212, the level of light measured by the proximity sensor 212 will increase above a threshold value, thereby detecting the presence of an object. The wavelength of the light may be in the non-visible spectrum (e.g., infrared). In other embodiments, the proximity sensor 212 may be electrical (e.g., capacitive or inductive), magnetic, or sonar based.

In another embodiment, the proximity sensor 212 may be implemented as part of a wireless communications protocol. For example, the device 200 may include a radio transceiver configured to operate according to a Bluetooth protocol. The radio transceiver may receive wireless signals via an antenna that are transmitted to the processor for processing. Similarly, the radio transceiver may transmit wireless signals from the antenna that can be received by a target object. The target object may also include a radio transceiver configured to communicate with the device 200 over a channel established via the wireless protocol. The signal strength of the radio transceivers may be adjusted to ensure that communications between the device 200 and the object only occurs when the device 200 and the object are close together (e.g., <10 cm). Thus, when communication between the device 200 and the target object is established, an application may trigger the presence of the target object, thereby functioning similar to a conventional proximity sensor. Another example of a proximity sensor 212 implemented as part of a communications protocol using wireless technology is via radio frequency identification (RFID) tags. The device 200 may include an RFID reader and the target object may include an RED tag. The RFID tag may be passive (i.e., require no power source) or active (requiring a power source). When the device 200 is brought within range of the RFID tag, the RFID tag may be read and the processor 202 indicates the presence of the target object.

The device 200 may be a cellular phone, tablet computer, game console, personal digital assistant (PDA) or other type of mobile electronic device. It will be appreciated that the components shown in FIG. 2 are for illustrative purposes only. The device 200 may include other components in addition to or in lieu of the components shown in FIG. 2.

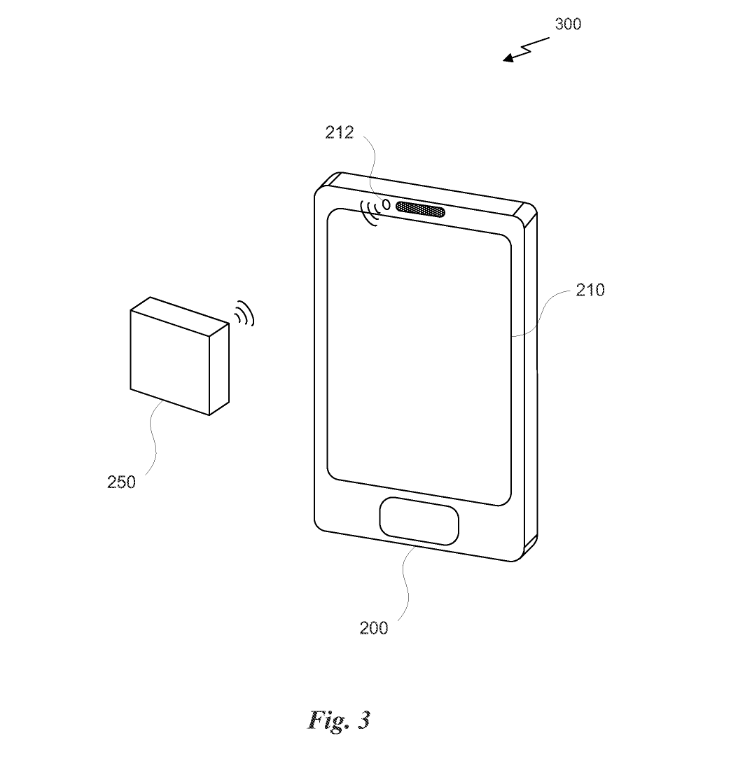

FIG. 3 illustrates a system 300 that includes a device 200 and a target object 250, in accordance with one embodiment. As shown in FIG. 3, the target object 250 may be a device such as a passive RFID tag embedded in a plastic housing. In another embodiment, the target object 250 may be a powered device that includes a separate power source (e.g., a battery) and a circuit for transmitting wireless signals. The target object 250 may be an active RFID tag or may include a radio transceiver and controller for connecting to the device 200 via a Bluetooth communications protocol or other such wireless protocol. When the user brings the device 200 in close proximity to the target object 250, the proximity sensor 212 detects the presence of the target object 250 and causes the display 210 to be deactivated.

In one embodiment, the device 200 may be configured to detect the target object 250 at a maximum range. The maximum range may be selected such that the device 200 functions normally (i.e., the display 210 is activated) when the device 200 is even a short distance from the target object 250. For example, the maximum range may be 10 centimeters such that the device 200 only needs to be moved a short distance from the target object 250 before the display 210 is activated. The device 200 may be configured by adjusting the signal strength of the proximity sensor 212, in the case where the proximity sensor is a radio transceiver, or adjusting a threshold value for a level of the signal produced by the proximity sensor 212 that triggers detection of the target object 250.

In one embodiment, the target object 250 may be a component of a larger apparatus or garment that is designed to be used with the device 200. For example, the target object may be designed into a case for the electronic device. When the case is closed, the target object is brought within range of the proximity sensor 212, thereby deactivating the display 210. However, when the case is open, the target object 250 is out of range of the proximity sensor 212, thereby activating the display 210 for normal use. In another embodiment, the target object 250 may be built into a garment, such as sewn into the pocket of a user's pants or sewn into the lining of a user's handbag. Thus, when the user places the device 200 into the pocket or into the handbag, the proximity sensor 212 is within range of the target object 250 and the display is deactivated.

It will be appreciated that deactivating the display 210 does not deactivate all functions of the device 200 (i.e., the device is not put to sleep). Instead, normal operation of the device 200 may be enabled, but output of the display 210 is simply deactivated. In one embodiment, the system (i.e., operating system, hardware, software, etc.) may detect that the display 210 is deactivated and put one or more components of the device 200 to sleep (i.e., via clock-gating or other power management techniques such as adjusting the operating clock frequency or supply voltage provided to the one or more components). For example, the device 200 may be configured to disable the GPU in the processor 202 whenever the display 210 is deactivated. The GPU may be placed in a sleep state and, optionally, clock-gated to save power.

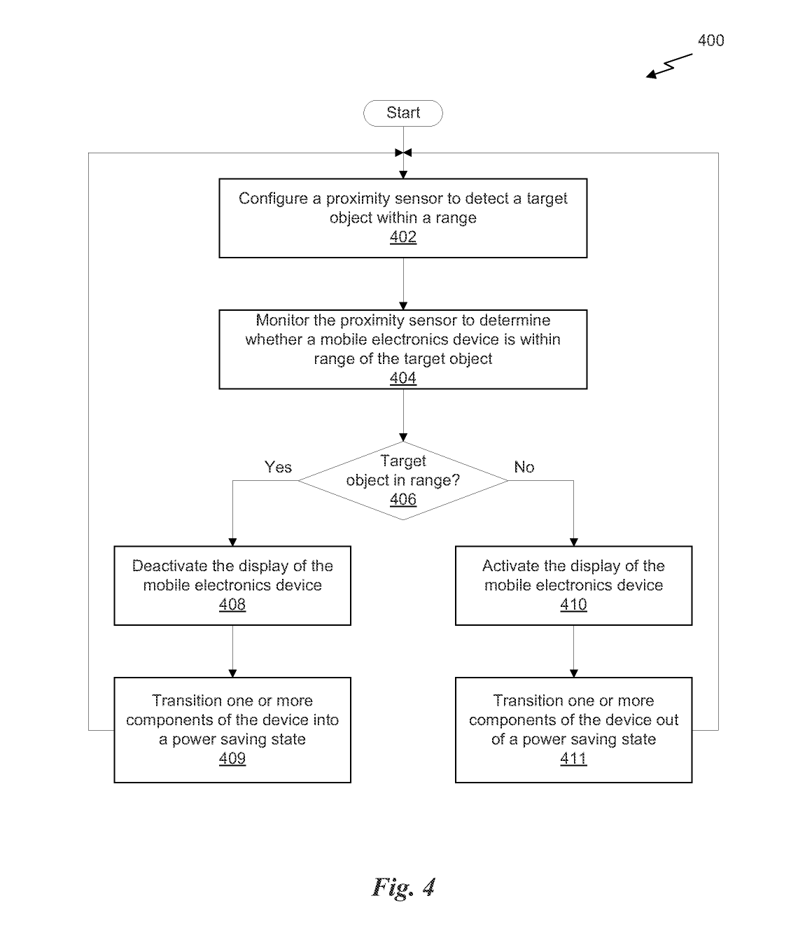

FIG. 4 illustrates a flowchart of a method 400 for controlling the display of a mobile electronics device 200 based on input from a proximity sensor 212, in accordance with another embodiment. At step 402, the device 200 configures the proximity sensor 212 to detect a target object 250 within a particular range. In one embodiment, an operating system of the device 200 adjusts a signal strength of the proximity sensor 212 to adjust the range at which the target object 250 is detected. In another embodiment, the operating system of the device 200 adjusts a threshold level of a signal generated by the proximity sensor 212 that triggers the detection of the target object 250. At step 404, the device 200 monitors the proximity sensor 212 to determine whether the device 200 is within range of the target object 250. At step 406, the device 200 determines if the target object 250 is within range. If the device 200 is within range of the target object 250, then, at step 408, the display 210 of the device 200 is deactivated. By deactivating the display 210, all backlights of the display are turned off and input (e.g., touch events) received by the display 210 is not transmitted to the processor 202 for processing. At step 409, one or more components of the device 200 are transitioned into a power saving state. For example, the CPU core of processor 202 may be clock-gated or power-gated to decrease energy consumption of the device 200. After step 409, the method 400 returns to step 404 where the proximity sensor is monitored to determine if the target object 250 is no longer in range.

However, returning to step 406, if the device 200 is not within range of the target object 250, then, at step 410, the display 210 of the device is activated. By activating the display 210, backlights to the display 210 are turned on and the display 210 is configured to receive image data (i.e., pixel values) for display. At step 411, one or more components of the device 200 are brought out of the power saving state and returned to normal operation. For example, clock-gating and/or power-gating may be turned off to return the components to a normal operating state. After step 411, the method 400 returns to step 404 where the proximity sensor is monitored to determine if the target object 250 is within range.

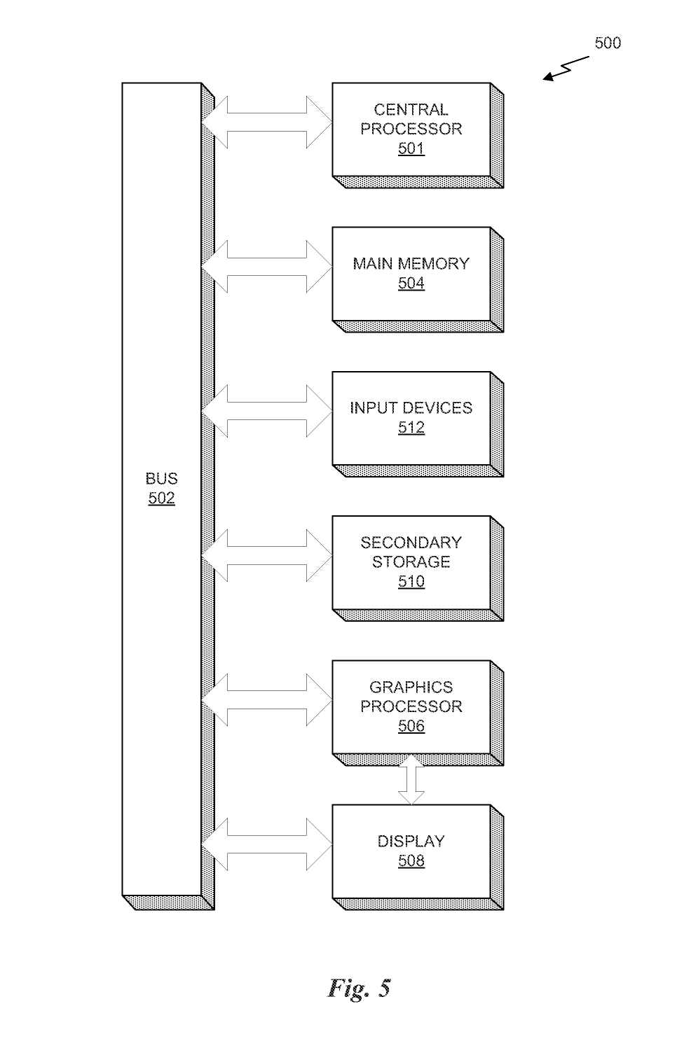

FIG. 5 illustrates an exemplary system 500 in which the various architecture and/or functionality of the various previous embodiments may be implemented. In one embodiment, the architecture of device 200 and/or target object 250 comprises at least a portion of the system 500. As shown, a system 500 is provided including at least one central processor 501 that is connected to a communication bus 502. The communication bus 502 may be implemented using any suitable protocol, such as PCI (Peripheral Component Interconnect), PCI-Express, AGP (Accelerated Graphics Port), HyperTransport, or any other bus or point-to-point communication protocol(s). The system 500 also includes a main memory 504. Control logic (software and data are stored in the main memory 504 which may take the form of random access memory (RAM).

The system 500 also includes input devices 512, a graphics processor 506, and a display 508, i.e. a conventional CRT (cathode ray tube), LCD (liquid crystal display), LED (light emitting diode), plasma display or the like. User input may be received from the input devices 512, e.g., keyboard, mouse, touchpad, microphone, and the like. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 504 and/or the secondary storage 510. Such computer programs, when executed, enable the system 500 to perform various functions. For example, a computer program may be configured to implement the method 400 or the method 100 for controlling the display of a mobile electronics device 200 based on input from a proximity sensor 212. The memory 504, the storage 510, and/or any other storage are possible examples of computer-readable media.

In one embodiment, the architecture and/or functionality of the various previous figures may be implemented in the context of the central processor 501, the graphics processor 506, an integrated circuit (not shown) that is capable of at least a portion of the capabilities of both the central processor 501 and the graphics processor 506, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, laptop computer, server, workstation, game consoles, embedded system, and/or any other type of logic. Still yet, the system 500 may take the form of various other devices including, but not limited to a personal digital assistant (PDA) device, a mobile phone device, a television, etc.

Further, while not shown, the system 500 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
monitoring a proximity sensor to determine whether a target object is within range of a device; and
if the target object is within range of the device, then deactivating a display of the device, or
if the target object is out of range of the device, then activating the display of the device.

2. The method of claim 1, wherein the proximity sensor comprises an ambient light proximity sensor, and wherein determining whether the target object is within range of the device comprises monitoring a level of a signal generated by the proximity sensor in response to a brightness of the ambient lights that strikes the proximity sensor.

3. The method of claim 1, wherein the proximity sensor comprises a radio transceiver configured to transmit and receive a wireless signal.

4. The method of claim 3, wherein determining whether the target object is within range of the device comprises attempting to establish a communications channel with the target object via the radio transceiver and, if the communications channel is established, then determining that the target object is within range of the device, or, if the communications channel is not established, then determining that the target object is out of range of the device.

5. The method of claim 4, wherein the communications channel is established according to a Bluetooth® protocol.

6. The method of claim 3, wherein the target object comprises a radio frequency identification (RFID) tag.

7. The method of claim 6, wherein the target object is a passive RFID tag.

8. The method of claim 1, wherein the range is approximately equal to or less than 10 centimeters.

9. The method of claim 1, further comprising configuring the proximity sensor to detect the target object at the range.

10. The method of claim 1, further comprising:
transitioning one or more components of the device into a power saving state when the target object is within range of the device, and
transitioning the one or more components out of the power saving state when the target object is out of range of the device.

11. The method of claim 10, wherein transitioning the one or more components into the power saving state comprises clock-gating the one or more components.

12. The method of claim 10, wherein transitioning the one or more components into the power saving state comprises power-gating the one or more components.

13. The method of claim 10, wherein transitioning the one or more components into the power saving state comprises adjusting a clock frequency or a supply voltage provided to the one or more components.

14. A non-transitory computer-readable storage medium storing instructions that, when executed by a processor, cause the processor to perform steps comprising:
monitoring a proximity sensor to determine whether a target object is within range of a device; and
if the target object is within range of the device, then deactivating a display of the device, or
if the target object is out of range of the device, then activating the display of the device.

15. The non-transitory computer-readable storage medium of claim 14, wherein the proximity sensor comprises an ambient light proximity sensor, and wherein determining whether the target object is within range of the device comprises monitoring a level of a signal generated by the proximity sensor in response to a brightness of the ambient lights that strikes the proximity sensor.

16. The non-transitory computer-readable storage medium of claim 14, wherein determining whether the target object is within range of the device comprises attempting to establish a communications channel with the target object via the radio transceiver and, if the communications channel is established, then determining that the target object is within range of the device, or, if the communications channel is not established, then determining that the target object is out of range of the device.

17. A system, comprising:
a target object; and
a device that includes a display and a proximity sensor, wherein the device is configured to:
monitor the proximity sensor to determine whether a target object is within range of the device, and
if the target object is within range of the device, then deactivate a display of the device, or
if the target object is out of range of the device, then activate the display of the device.

18. The system of claim 17, wherein the proximity sensor comprises a radio transceiver configured to transmit and receive a wireless signal.

19. The system of claim 18, herein the target object comprising a radio frequency identification (RFID) tag.

20. The system of claim 17, the device further comprising a processor that includes two or more components as a system-on-chip (SoC).
